(19) United States
(12) Patent Application Publication
(10) Pub. No.: US 2008/0000210 A1
(43) Pub. Date: Jan. 3, 2008

(54) Reciprocating breakaway knife

(75) Inventor: David D. Jolly, Pleasantville, IA (US)

Correspondence Address: HAYNES AND BOONE, LLP, 901 Main Street, Suite 3100, Dallas, TX, 75202, US

(73) Assignee: Alamo Group, Inc., Seguin, TX (US)

(21) Appl. No.: 11/480,741

(22) Filed: Jul. 3, 2006

(51) Int. Cl. A01D 34/30

(52) U.S. Cl. 56/257

(57) ABSTRACT

A knife section for a mower provides a base portion and at least one knife extending longitudinally from the base portion. Each knife includes a single breakage hole having a length extending longitudinally from the base. The breakage hole includes opposed non-parallel sides defining a variable width hole along its length. The hole provides for permitting the knife to break along a region which transversely intersects the non-parallel sides.

### BACKGROUND

The disclosures herein relate generally to reciprocating sickle bar mowers and more particularly to a knife having a confined breakage area.

Reciprocating sickle bar mowers include a plurality of knives mounted on a sickle bar. Breakage may occur where, for example, a knife contacts a stone or other foreign object. These knives are usually “through hardened” to promote breakage before bending, otherwise other portions of the sickle bar may be damaged. Breakage can be substantially confined to an area of the knife by providing a means to cause the knife to break free of a host cutting device when encountering a potential damage causing object.

### SUMMARY

One embodiment, accordingly, provides a base portion and a knife portion extending longitudinally from the base portion. The knife portion includes a single breakage hole having a length extending longitudinally from the base. The breakage hole includes opposed non-parallel sides defining a variable width hole along its length.

### BRIEF DESCRIPTION OF THE DRAWINGS

FIG. 1 illustrates an embodiment of a harvesting machine.

FIG. 2 illustrates an embodiment of a sickle bar mower.

FIG. 3a illustrates an embodiment of a knife section.

FIG. 3b illustrates an embodiment of a knife section.

FIG. 3c illustrates an embodiment of a knife section.

### DETAILED DESCRIPTION

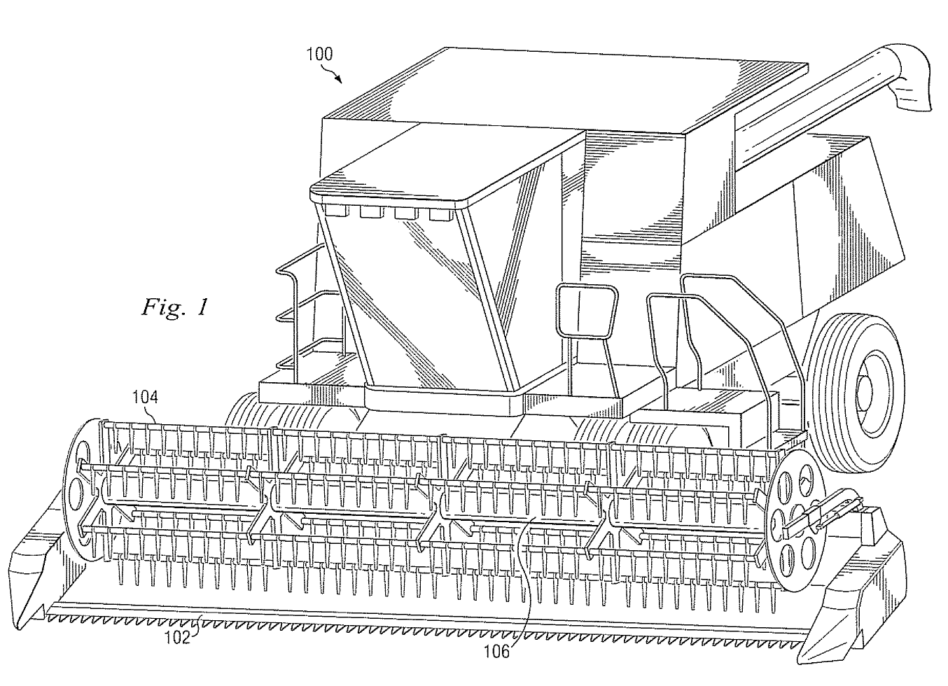

A harvesting machine 100, FIG. 1, is of a type which uses a reciprocating sickle bar mower 102 for cutting crop material to be fed into the harvesting machine 100 by means of a reel 104 and an auger 106.

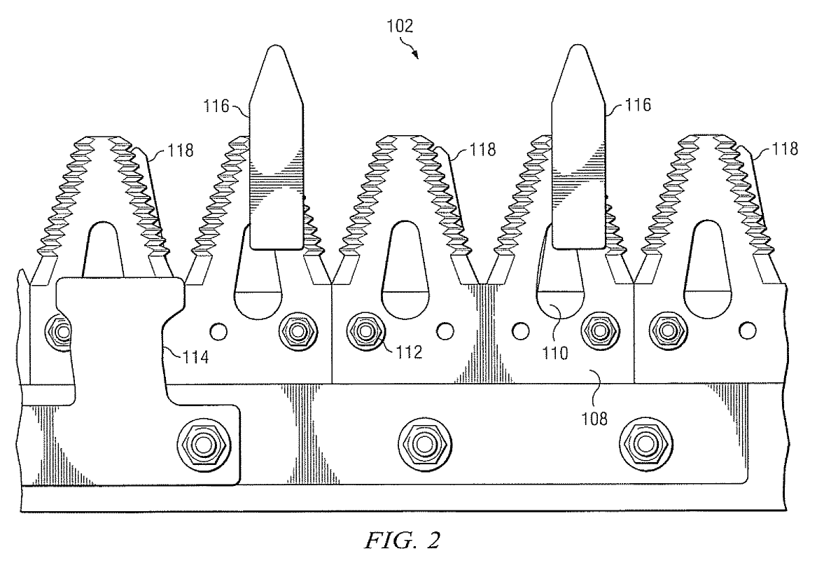

The sickle bar mower 102, FIG. 2, typically includes a plurality of double knife sections 108 mounted on a sickle bar 110 by bolts 112. A clip member 114 and a guard finger 116 are stationary members and the knife sections 108 reciprocate with bar 110 relative to an associated stationary cutting member 118, to provide a reciprocating cutting action sufficient to cut the crop material.

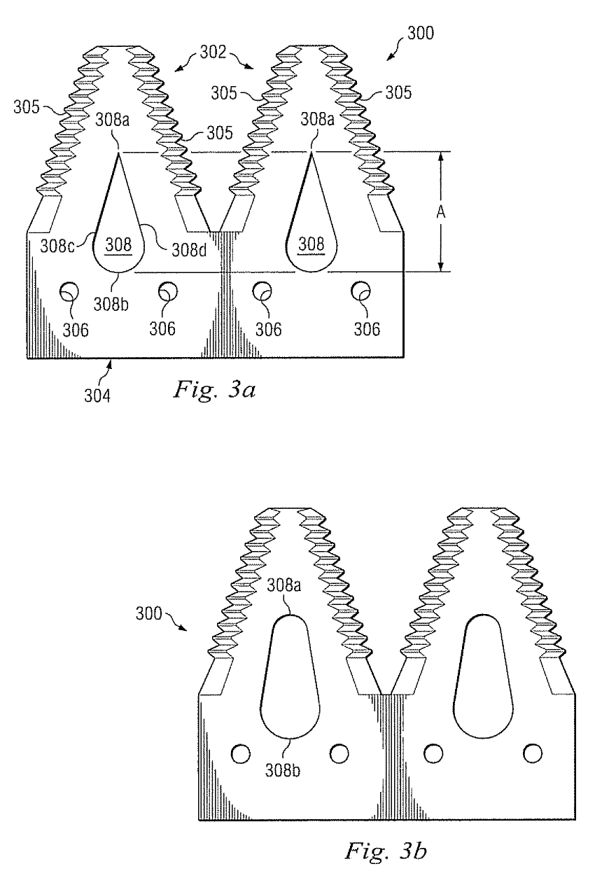

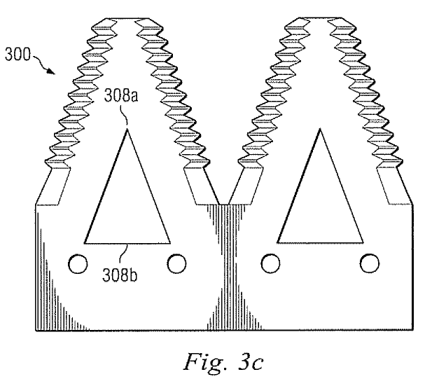

More specifically, in FIGS. 3a, 3b and 3c, a mower knife section 300 is illustrated and each mower knife section 300 includes a pair of knives or knife portions 302 having a base portion 304. The base portion 304 includes a plurality of mounting holes 306 for mounting the base portion 304 to the sickle bar as briefly discussed above. The base portion 304 is mounted by a suitable attachment means such as bolts also discussed above. Each mower knife 302 extends longitudinally from its respective base portion 304.

Each knife 302 is generally of a triangular shape and includes two cutting edges 305, which are illustrated as serrated. Each knife 302 is provided with only one breakage hole 308, having a length extending longitudinally with its respective knife 302. The breakage hole 308 is generally of a triangular or teardrop shape including opposite ends 308a, 308b, and opposite, non-parallel sides 308c, 308d, thus defining a variable width hole 308 along the length thereof.

As a result of this construction, the opposite sides 308c, 308d, converge toward the end 308a and diverge toward the end 308b. One of the ends 308b, FIG. 3a, may be curvilinear. As an alternative, FIG. 3b both of the ends 308a, 308b, may be curvilinear. As a further alternative, FIG. 3c, one of the ends 308b may be rectilinear.

The hole 308 causes an area or region of weakness in the knife 302 so that a breakaway knife is formed, with breakage being substantially confined to the area or region A, proximate the breakage hole 308. Thus, the hole 308 provides a means for permitting the knife 302 to break substantially in the region A which transversely intersects the non-parallel sides 308c, 308d at some point between ends 308a and 308b. The purpose of the confined breakage is to limit potential damage to other portions of the sickle bar and for ease of replacement via the mounting holes 306 and their associated attachment means.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A knife for a mower comprising:
a base portion; and
at least one knife extending longitudinally from the base portion, each knife including only one breakage hole having a length extending longitudinally therewith and opposed non-parallel sides defining a variable width hole along its length.

2. The knife as defined in claim 1 wherein the hole has a generally triangular shape.

3. The knife as defined in claim 1 wherein the sides converge toward a first end of the hole and diverge toward a second end of the hole.

4. The knife as defined in claim 3 wherein the first and second ends are curvilinear.

5. A mower having a reciprocating sickle bar comprising:
a knife mounted on the sickle bar and having a base and at least one knife; and
each knife extending longitudinally from the base portion, each knife including only one breakage hole having a length extending longitudinally therewith and having opposite ends and opposite sides, the opposite sides converging toward one of the ends and diverging toward the other of the ends for defining a variable width hole.

6. The mower as defined in claim 5 wherein the hole has a generally triangular shape.

7. The mower as defined in claim 5 wherein one of the ends of the hole is curvilinear.

8. The mower as defined in claim 5 wherein one of the ends of the hole is rectilinear.

9. The mower as defined in claim 5 wherein the opposite ends of the hole are curvilinear.

10. A method for providing a breakage hole in a mower knife comprising:
providing a base portion;
extending at least one knife longitudinally from the base portion;
forming only one variable width elongated breakage hole in each knife;
extending the hole longitudinally within the knife; and
providing the hole with opposed non-parallel sides defining the variable width of the hole.

11. The method as defined in claim 10 wherein the hole has a generally triangular shape.

12. The method as defined in claim 10 wherein the sides converge toward a first end of the hole and diverge toward a second end of the hole.

13. The method as defined in claim 12 wherein one of the ends is curvilinear.

14. The method as defined in claim 12 wherein one of the ends is rectilinear.

15. A mower knife breakage system comprising:
a plurality of mower knife sections each including:
a base portion;
at least one knife extending longitudinally from the base portion; and
only one variable width elongated breakage hole provided in each knife, each hole having opposite ends and opposite sides, the opposite sides being non-parallel defining the variable width of the hole and one of the ends being of a greater width than the other of the ends.

16. The system as defined in claim 15 wherein the knife has generally triangular shape and the hole has a generally triangular shape.

17. The system as defined in claim 15 wherein one of the ends of the hole is curvilinear.

18. The system as defined in claim 15 wherein the opposite ends of the hole are curvilinear.

19. The system as defined in claim 15 wherein one of the ends of the hole is rectilinear.

20. The system as defined in claim 15 wherein the hole provides a means for permitting the knife to break a region which transversely intersects the non-parallel side.
